(19) United States
(12) Patent Application Publication
(10) Pub. No.: US 2026/0048748 A1
(43) Pub. Date: Feb. 19, 2026

(54) METHOD FOR CONTROLLING A DRIVE TRAIN AND DRIVE TRAIN

(71) Applicant: ZF Friedrichshafen AG, Friedrichshafen (DE)

(72) Inventors: Michael GROSSMANN, Horgenzell (DE); Rick HAUSCHWITZ, Friedrichshafen (DE); Tobias STAUBER, Mellau (AT); Tobias KOHR, Bodnegg (DE); Zeyneba RUHF, Meersburg (DE); Reiner KNEER, Dornbirn (AT); Georg WILLMANN, Markdorf (DE); Verena MESZAROS, Meckenbeuren (DE); Patrick KELLNER, Ravensburg (DE); Usama MASUD, Friedrichshafen (DE)

(73) Assignee: ZF Friedrichshafen AG, Friedrichshafen (DE)

(21) Appl. No.: 19/297,256

(22) Filed: Aug. 12, 2025

(30) Foreign Application Priority Data
Aug. 14, 2024 (DE) 10 2024 207 734.8

(51) Int. Cl. B60W 30/188; B60W 10/08; B60W 10/10

(52) U.S. Cl. CPC B60W 30/188; B60W 10/08; B60W 10/10; B60W 2510/1005; B60W 2710/083; B60W 2710/105

(57) ABSTRACT

A method is provided for controlling a drive-train (12) of a motor vehicle (10) having at least one first drive motor (16), a second drive motor (18), and a transmission (20) for taking up the drive torques (M₁, M₂) of the first drive motor (16) and the second drive motor (18). The method includes determining a torque (M_{FW}) desired by the driver, determining a shift position of at least one first shifting element (64) of the transmission (20), and calculating a nominal torque (M_{S}) on the basis of the torque (M_{FW}) desired by the driver, a drive torque (M₁) of the first drive motor (16), and the shift position of the at least one first shifting element (64) of the transmission (20).

### RELATED APPLICATIONS

This application claims the benefit of and right of priority under 35 U.S.C. § 119 to German Patent Application no. 10 2024 207 734.8, filed on 14 Aug. 2024, the contents of which are incorporated herein by reference in its entirety.

### TECHNICAL FIELD

The invention relates to a method for controlling a drive train in a motor vehicle, according to the present disclosure. The invention also relates to a control unit, a drive train, a motor vehicle, a computer program, and a computer-readable medium.

### BACKGROUND

From the prior art, drive trains for motor vehicles are known, which comprise one or more drive motors and a transmission for gearing up or down and distributing the drive torque provided by the drive motor(s). In drive trains with more than one drive motor, in particular hybrid drive trains with an electric drive motor and an internal combustion engine or electric drive trains with more than one electric drive motor, the challenge is imposed upon the transmission of taking up the drive torques from a plurality of drive motors and transmitting them in combined form to a drive output of the transmission.

Particularly in drive trains with two electric drive motors, a nominal torque must be specified for each electric drive motor, which is primarily derived from the positioning of the accelerator pedal by a driver of the motor vehicle. In order to control the drive train as required, this torque called for by the driver must be adapted to match the desired torque on the driven axle.

DE 10 2019 214 986 A1 discloses an electrically driven motor vehicle with an electric drive train comprising two electric drive motors. The electric drive motors can be coupled by a shiftable transmission in such manner that the drive torque of the first electric drive motor is transmitted to a first input of the transmission. In a first shift position of the transmission, the drive torque of the second electric drive motor can also be transmitted to the same input of the transmission, so that the two drive torques are directly added to one another. In a second shift position of the transmission, the drive torque of the second electric drive motor can be transmitted to a second input of the transmission different from the first input, so that the drive torque is geared to a value higher or lower compared with the drive torque transmitted in the first shift position. Thus, a calculation of a transmission output torque takes place on the basis of the shift position of the transmission.

### SUMMARY

The purpose of the present invention is to enhance the functional reliability of a drive train and to overcome or at least reduce the known disadvantages of the prior art.

This objective is achieved by a method for controlling a drive train of a motor vehicle that comprises at least a first drive motor, a second drive motor, and a transmission for taking up the drive torques of the first drive motor and the second drive motor. The method has the following steps:
determination of a torque desired by the driver,
determination of a shift position of at least one first shifting element of the transmission,
calculation of a nominal torque on the basis of the torque desired by the driver, a drive torque of the first drive motor, and the shift position of the at least one first shifting element of the transmission.

A motor vehicle can in principle be used to provide any means of transport over land, water, and/or in the air, for example in passenger cars, trucks, buses, autonomously-driving passenger or load transporters, emergency operations vehicles, working vehicles (such as fork-lift transporters), building-site vehicles such a concrete mixers, baggers or the like, flying machines such as aircraft, helicopters, drones, air taxis or the like, and/or boats or ships, but also motorized two-wheeled vehicles such as motorcycles or electrically powered bicycles.

In that context, a drive train is understood to mean a unit that enables the motor vehicle to move independently of forces acting from the outside upon the motor vehicle, in particular independently of gravity. Such a drive train comprises in particular a drive motor and a power transmission unit that connects the drive motor to a further drive element.

In this context, a drive motor is understood to mean an electric drive motor or an internal combustion engine. Preferably, a drive train with two electric drive motors is provided. Alternatively, the drive train can be in the form of a hybrid drive train comprising an electric drive motor and an internal combustion engine.

In this context, a transmission is understood to mean a unit that converts an input torque from a drive motor to an output torque at a drive output.

In this context, a drive torque is understood to mean a torque produced by one of the drive motors or by both of the drive motors.

In this context, a torque desired by a driver is understood to mean a drive torque for the motor vehicle that corresponds to a drive torque desired by the driver and to be provided by the drive motors.

In this context, a nominal torque is understood to mean a torque of one of the drive motors which is suitable for providing the torque desired by the driver.

In this context, a shift position of the transmission is understood to mean a position of the transmission in which a drive torque with a fixed transmission ratio is transmitted by the transmission to the drive output or in which no drive torque is transmitted because a torque-transmitting connection between the drive motor and the transmission has been broken.

In a drive train with two drive motors, the method according to the invention makes it possible in a simple and inexpensive manner to ensure functional reliability of the drive train and in particular to protect the drive train against damage caused by excessive torque. In this context, it is proposed that for calculating the nominal torque in relation to the drive output of the transmission, only the parameters are taken into account that are essential for control purposes, while no account is taken of other parameters in calculating the nominal torque.

In this respect, it has been shown, with the solutions known from the prior art, that a situation-dependent calculation of a distribution factor of the torque desired by the driver to the two drive motors can be inaccurate, non-reproducible, and prone to error when used for the reliability function. Since, in relation to a torque desired by the driver, the driving function and the functions for the functional reliability of the drive train are realized separately in the systems known from the prior art, this demands much functional effort and correspondingly large computing power. A discrepancy in the calculation due to unstably determined values can result in susceptibility to errors and deficient robustness of the functional reliability functions. By virtue of the method according to the invention, the computing power required can be reduced and the robustness in relation to functional reliability can be increased, since for functional reliability having a larger actual torque compared with the nominal torque is exclusively important. In relation to functional reliability, falling below the nominal torque is not critical.

In typical embodiments of the method, the nominal torque is calculated on the assumption that the second drive motor is coupled to the first drive motor in such manner that the drive torque of the first drive motor and the drive torque of the second drive motor are supplied to the transmission by way of a common input. In that way, the input conditions for calculating the nominal torque can be made simpler, whereby the computing power required is reduced still more and the robustness of the computing process increased further. A shift position of a shifting element which couples the second drive motor to the first drive motor can therefore be ignored in the calculation of the nominal torque.

In an advantageous design of the method, it is provided that the calculation of the nominal torque is carried out under the assumption that the second drive motor is connected with the first drive motor in a torque-transmitting manner, so that the calculation is carried out regardless of the actual coupling between the first and second drive motors. The result of such an assumption is that the torque determined is larger than or equal to the actual torque. However, since falling below the nominal torque is not critical for the functional reliability, such a simplification is possible.

In an advantageous embodiment of the method, it is provided that the nominal torque is calculated under the assumption that the whole of the torque desired by the driver is generated by the first drive motor. This assumption enables a further simplification of the computing process.

According to a preferred embodiment of the method, it is provided that the calculation of the nominal torque is carried out independently of a distribution factor between the actual drive torque of the first drive motor and the actual drive torque of the second drive motor. By virtue of a calculation in which only the drive torque at an input of the transmission is taken into account independently of the distribution between the two drive motors, the method for controlling the drive train can be correspondingly simplified and the functional reliability thereby increased.

In a further advantageous embodiment of the method, it is provided that a calculation of the nominal torque is carried out with a shift position of the first shifting element in which the second drive motor is connected to the transmission in a torque-transmitting manner, by a conversion via a selected transmission ratio of the transmission. In a shift position in which the second drive motor is decoupled from the transmission and does not transmit any torque, the calculation is carried out via a fictional coupling with a fixed transmission ratio of the transmission.

In typical embodiments, the transmission is in the form of a shiftable multi-gear transmission and the calculation of the nominal torque is carried out with a torque-transmitting connection of the second drive motor to the transmission by the transmission ratio of the chosen gear in the transmission. In a shift position in which the second drive motor is decoupled from the transmission and does not transmit any torque, the calculation is carried out by virtue of a fictional assumption of the smallest transmission ratio of the transmission. Thus, in a neutral position or during a gearshift, the larger drive output torque is always specified.

A further partial aspect of the invention relates to a control unit for controlling a drive train in a motor vehicle, wherein the control unit is functionally connected to two drive motors and a transmission of the drive train. The control unit is designed to carry out a method as described in the preceding paragraphs, in particular when a machine-readable computer program is carried out by the control unit.

A further partial aspect of the invention relates to a drive train for a motor vehicle having a first drive motor and a second drive motor. In this case, a transmission of the drive train is connected on its input side to the first drive motor and the second drive motor. The drive train also comprises a control unit described in the previous section for controlling the drive motors and the transmission.

In a preferred design of the drive train, it is provided that the first drive motor is a first electric motor and the second drive motor is a second electric motor.

A further partial aspect of the invention relates to a computer program, which contains commands that, when the computer program is run on a computer, enable it to carry out one of the aforesaid methods. The computer program can also be called a computer program product.

A further partial aspect of the invention relates to a computer-readable medium which contains computer program codes for carrying out one of the methods described in the preceding sections for operating a drive train in a motor vehicle. The term “computer-readable medium” is understood to mean, in particular but not exclusively, hard disks and/or servers and/or memory sticks and/or flash memories and/or DVDs and/or Bluerays and/or CDs. In addition, the term “computer-readable medium” is also understood to include a data stream such as that produced, for example, when a computer program and/or a computer program product is downloaded from the Internet.

### BRIEF DESCRIPTION OF THE DRAWINGS

Below, the invention is explained briefly with reference to drawings, which show:

FIG. 1: a schematic view of a drivetrain for a motor vehicle, which is controlled by a method according to the invention for controlling a drivetrain.

FIG. 2: a preferred embodiment of a drivetrain for a motor vehicle according to the invention, which is controlled by a method according to the invention for controlling a drivetrain.

FIG. 3: a schematic representation of a preferred embodiment of a drivetrain for a motor vehicle according to the invention.

FIG. 4: a motor vehicle with a drivetrain according to the invention.

FIG. 5: a table with gear ratios for the output torque as a function of the control of the drive motors and the shift positions in a transmission of the drivetrain.

FIG. 6: a flowchart for implementing a method according to the invention for controlling a drivetrain of a motor vehicle.

### DESCRIPTION OF PREFERRED EXAMPLE EMBODIMENTS

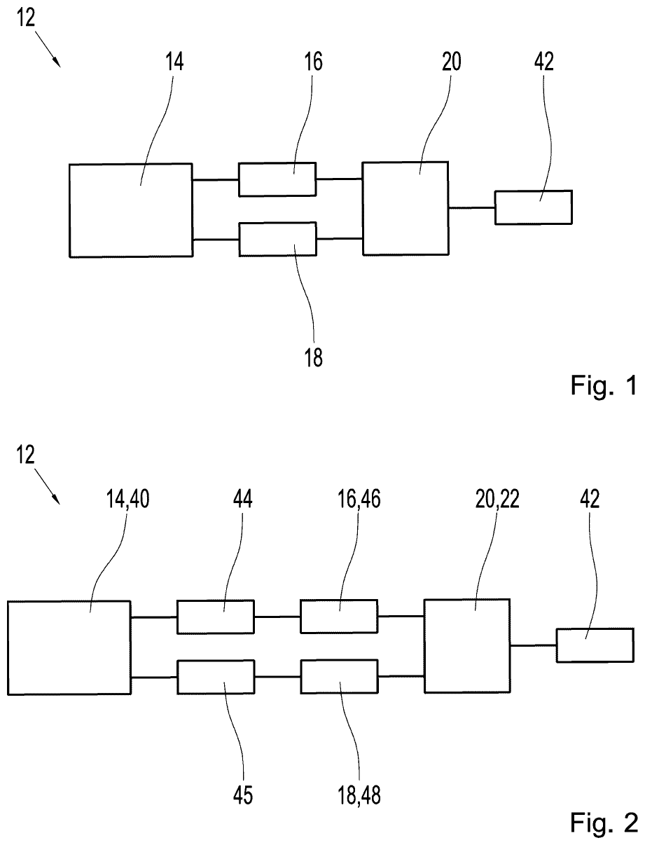

FIG. 1 shows a schematic view of a drive train 12 for a motor vehicle 10. The drive train 12 comprises an energy supply unit 14, a first drive motor 16 connected to the energy supply unit 14 and a second drive motor 18 connected to the energy supply unit 14. The first drive motor 16 and the second drive motor 18 are connected by way of a common transmission 20 to a drive output 42, the transmission 20 being in the form of a summation transmission which can take up the drive torque M₁ of the first drive motor 16 and the drive torque M₂ of the second drive motor 18 individually or together, and pass it or them on to the drive output 42.

FIG. 2 shows a preferred example embodiment of such a drive train 12 for a motor vehicle 10. The drive train 12 comprises an energy supply unit 14 in the form of a high-voltage battery 40. Such a high-voltage battery 40, however, need not exclusively be of the lithium-ion accumulator, lithium-iron phosphate accumulator, solid electrolyte accumulator, or sodium-ion accumulator type. The drive train 12 also comprises a first inverter 44 which connects the energy supply unit 14 to the first drive motor 16. In this example embodiment, the first drive motor 16 is in the form of a first electric drive motor 46. The drive train 12 further comprises a second inverter 45, which connects the energy supply unit 14 to the second drive motor 18. The second drive motor is in the form of a second electric drive motor 48.

The first electric drive motor 46 and the second electric drive motor 48 are connected to a common transmission 20, which is in the form of a summation transmission, in particular a planetary transmission 22. The transmission 20 has a drive output 42 by way of which a drive torque M₁ of the first drive motor 16 and/or a drive torque M₂ of the second drive motor 18 are transmitted to a drive axle 50 of a motor vehicle 10.

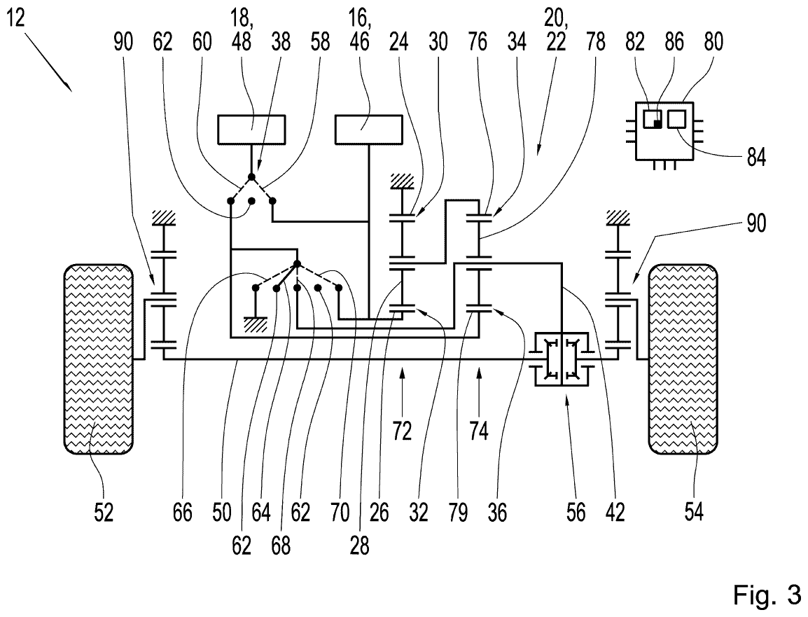

FIG. 3 shows a schematic representation of a preferred example embodiment of a drive train 12 according to the invention for a motor vehicle 10. The drive train 12 comprises a first electric drive motor 46 and a second drive motor 48, which are connected by way of a planetary transmission 22 to a common drive output 42. The drive output 42 is connected to a differential 56 of a drive axle 50, which distributes the drive torque via axle transmissions 90 to the driven wheels 52, 54 of the drive axle 50.

The planetary transmission 22 comprises a first ring gear 24, which is in functional connection via first teeth 30 with first planetary gearwheels 28 of a first planetary gearset 72. By way of a first sun gear 26 of the first planetary gearset 72 the drive torque M₁ of the first electric drive motor 46 is transmitted via second teeth 32 to the first planetary gearwheels 28 of the first planetary gearset 72 of the planetary transmission 22. The planetary gearwheels 28 of the first planetary gearset 72 are connected via a first planetary carrier with a second ring gear 76 of a second planetary gearset 74 and drive the latter. The second ring gear 76 meshes via third teeth 34 with second planetary gearwheels 78 of the second planetary gearset 74, which mesh via fourth teeth 36 with a second sun gear 79 of the second planetary gearset 74. A planetary carrier of the second planetary gearset 74 forms a drive output 42 of the planetary transmission 22, which is connected to a differential 56 of a drive axle 50. By way of the differential 56 and a further axle transmission 90 the drive torque is distributed to a first driven wheel 52 and a second driven wheel 54 of the drive axle 50.

The second electric drive motor 48 can be connected by a second shifting element 38 via a first shifting path 58 to the first electric drive motor 46. By way of a second shifting path 60, the second electric drive motor 48 can also be connected to a first shifting element 64. Between the first shifting path 58 and the second shifting path 60 of the second shifting element 38, a neutral position 62 is provided in which the second electric drive motor does not transmit any torque.

The first shifting element 64 enables three different transmission ratios for the second drive motor 46 to be produced. In a first shifting path 66 of the first shifting element 64, the drive torque M₂ of the second electric drive motor 48 is transmitted to the second sun gear 79 of the planetary transmission 22. In a second shifting path 68, torque is transmitted from the second electric drive motor 48 to the planetary carrier of the second planetary gearset 74 of the planetary transmission 22. In a third shifting path 70, torque is transmitted from the second electric drive motor 48 to the first sun gear 26 of the planetary transmission 22. In addition, by means of the first shifting element 64, neutral positions 62 can be produced in which no torque is transmitted to the planetary transmission 22.

The drive train 12 also comprises a control unit 80 for controlling the first drive motor 16 and the second drive motor 18. The control unit 80 is also connected to the planetary transmission 22 in order to process signals from the planetary transmission 22, in particular the shift positions of the shifting elements 38, 64, and take them into account for the control of the drive train 12. The control unit 80 comprises a memory unit 82 and a computer unit 84. In the memory unit 82 there is stored a computer program code 86 for carrying out a method according to the invention for controlling the drive train 12, which carries out such a method when the computer program code 86 is run on the computer unit 84.

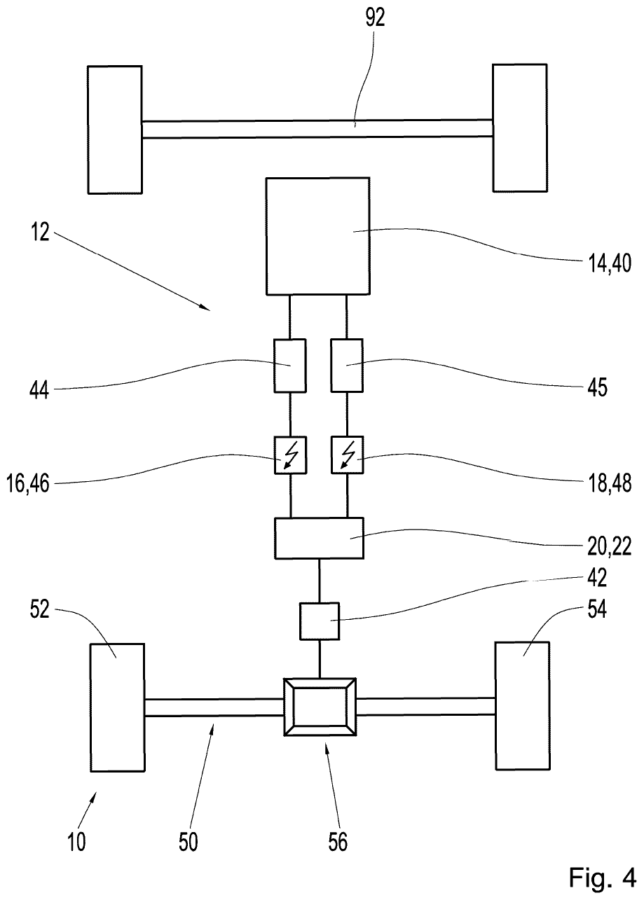

FIG. 4 shows a schematic representation of a motor vehicle 10 with a drive train 12 according to the invention. The motor vehicle 10 comprises an energy supply system 14 that includes a high-voltage battery 40. The drive train 12 also comprises a first inverter 44 which connects the energy supply unit 14 to the first drive motor 16. In this example embodiment the first drive motor 16 is in the form of a first electric drive motor 46. The drive train 12 also comprises a second inverter 45 which connects the energy supply unit 14 to the second drive motor 18. The second drive motor is also in the form of a second electric drive motor 48.

The first electric drive motor 46 and the second electric drive motor 48 are connected to a common transmission 20, which is in the form of a summing transmission, in particular a planetary transmission 22. The transmission 20 has a drive output 42 by way of which a drive torque M₁ of the first drive motor 16 and/or a drive torque M₂ of the second drive motor 18 is/are transmitted to a drive axle 50 of a motor vehicle 10. The motor vehicle 10 also has a second, non-driven axle 92.

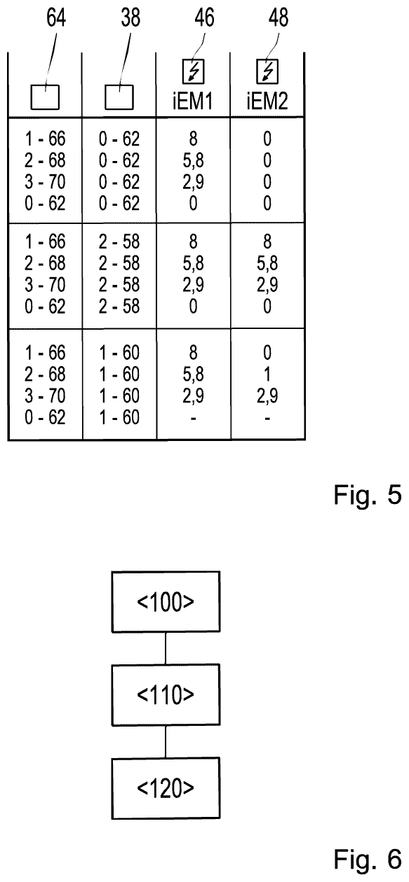

FIG. 5 shows a table which indicates as examples transmission ratios for a drive torque of the transmission 20 as a function of a shift position of a first shifting element 64 and a second shifting element 38 of the transmission 20 and the input torques of the drive motors 16, 18. From this it can be seen that by means of the transmission 20 three different transmission ratios can be produced.

FIG. 6 shows a flow chart for carrying out a method according to the invention for the control of a drive train 12 of a motor vehicle 10 with a first drive motor 16, in particular a first electric drive motor 46, and a second drive motor 18, in particular a second electric drive motor 48, as well as a transmission 20 in the form of a planetary transmission 22, wherein the planetary transmission 22 is connected on its input side to the first drive motor 16 and the second drive motor 18, and acts as a summing transmission which transmits the drive torques M₁, M₂ of the first drive motor 16 and the second drive motor 18 to a common drive output 42.

In a process step <100> a torque M_{FW} desired by the driver is determined. In a process step <110> a shift position of a first shifting element 64 of the transmission 20 is detected. In this case the process steps <100> and <110> can be carried out in any desired sequence one after the other, or in parallel. In a process step <120> a nominal torque M_{S} is determined on the basis of the torque M_{FW} desired by the driver, and a drive torque M₁ of the first drive motor 16 and a shift position of the first shifting element 64 of the transmission 20 are also determined.

In this case the nominal torque M_{S} is calculated by a method in which, on the basis of the transmission geometry of the transmission 20, one of the shifting elements 38, 64 is defined as the central and master shifting element 64, whereas the other shifting element 38 is considered to be irrelevant. With the geometry of the transmission 20 described in particular in FIG. 3, this is possible by virtue of the geometry of the transmission 20, In that case the first shifting element 64 is considered to be the central shifting element while the position of the second shifting element 38 is disregarded.

Furthermore, to calculate the nominal torque M_{S} it is assumed that the whole of the driver-desired torque M_{FW} is generated by a drive motor 16, namely in the geometry of the drive train 12 described, by the first drive motor 16. Analogously, it is assumed that the second shifting element 38 is always in a shift position in which the second drive motor 18 is connected to the first drive motor 16 via the first shifting path 58.

Depending on the shift position of the first shifting element 64, the torque M_{FW} desired by the driver is produced by way of the transmission ratio produced by the shifting path 66, 68, 70 concerned.

If the first shifting element 64 is in a neutral shift position, then the nominal torque M_{S} is calculated as a function of the driver-desired torque M_{FW} via the transmission ratio of the first shifting path 66. If the first shifting element 64 is in a neutral shift position between the second shifting path 68 and the third shifting path 70, then the nominal torque M_{S} is calculated as a function of the driver-desired torque M_{FW} via the transmission ratio of the second shifting path 68. Thus, in a neutral position or during a gearshift the larger drive torque is always specified as the nominal torque M_{S}.

An advantage of this calculation method is that there is no susceptibility to error and a substantial simplification of the calculation of the nominal torque M_{S} is made possible. This results in the need for substantially less computing power, since there is no need to calculate the two torques and a distribution factor separately. Furthermore, the calculation can take place regardless of the shift position of the second shifting element 38. Thereby, in a simple manner a method is provided with which sufficient accuracy for the control and functional reliability of the drive train 12 is achieved. In addition, the availability of the vehicle is increased since error-prone interventions to ensure functional reliability of the drive train 12 are avoided or reduced.

The invention is not limited to the example embodiments described. Its protective scope is defined by the claims.

In principle, all the methods described in the description or in the claims can be carried out by equipment that includes means for carrying out the respective process steps of the methods.

### INDEXES

10 Motor vehicle
12 Drive train
14 Energy supply
16 First drive motor
18 Second drive motor
20 Transmission
22 Planetary transmission
24 First ring gear
26 First sun gear
28 First planetary gearwheel
30 First teeth
32 Second teeth
34 Third teeth
36 Fourth teeth
38 Second shifting element
40 High-voltage battery
42 Drive output
44 First inverter
45 Second inverter
46 First electric motor
48 Second electric motor
50 First axle/drive axle
52 First wheel
54 Second wheel
56 Differential
58 First shifting path of second shifting element
60 Second shifting path of second shifting element
62 Neutral position
64 First shifting element
66 First shifting path of first shifting element
68 Second shifting path of the first shifting element
70 Third shifting path of the first shifting element
72 First planetary gearset
74 Second planetary gearset
76 Second ring gear
78 Second planetary gearwheel
79 Second sun gear
80 Control unit
82 Memory unit
84 Computer unit
86 Computer program code
90 Axle transmission
92 Second axle
M₁ Drive torque of the first drive motor
M₂ Drive torque of the second drive motor
M_{FW} Torque desired by the driver
M_{S} Nominal torque

1. A method for controlling a drive-train (12) of a motor vehicle (10) with at least one first drive motor (16), a second drive motor (18) and a transmission (20) for taking up the drive torques (M₁, M₂) of the first drive motor (16) and the second drive motor (18), the said method comprising the following steps:
determining a torque (M_{FW}) desired by the driver;
determining a shift position of at least one first shifting element (64) of the transmission (20); and
calculating a nominal torque (M_{S}) on the basis of the torque (M_{FW}) desired by the driver, a drive torque (M₁) of the first drive motor (16), and the shift position of the at least one first shifting element of the transmission (20).

2. The method according to claim 1, wherein calculating the nominal torque (M_{S}) takes place under the assumption that the second drive motor (18) is coupled to the first drive motor (16) in such manner that the drive torque (M₁) of the first drive motor (16) and the drive torque (M₂) of the second drive motor (18) are transmitted to the transmission (20) via a common input.

3. The method according to claim 2, wherein the calculating is carried out under the assumption that the second drive motor (18) is connected to the first drive motor (16) in a torque-transmitting manner, so that the calculation of the nominal torque (M_{S}) is carried out regardless of an actual coupling between the first drive motor (16) and the second drive motor (18).

4. The method according to claim 1, wherein calculating the nominal torque (M_{S}) is carried out under the assumption that all of the torque (M_{FW}) desired by the driver is generated by the first drive motor (16).

5. The method according to claim 1, wherein calculating the nominal torque (M_{S}) is carried out regardless of a distribution factor between the actual drive torque (M₁) of the first drive motor (16) and the actual drive torque (M₂) of the second drive motor (18).

6. The method according to claim 1, wherein calculating the nominal torque (M_{S}) at the shift position of the at least one first shifting element (64) in which the second drive motor (18) is connected to the transmission (20) in a torque-transmitting manner, takes place by a conversion via a selected transmission ratio of the transmission (20), and at a shift position in which the second drive motor (18) is decoupled from the transmission (20) via a fictional coupling with a fixed transmission ratio.

7. The method according to claim 6, wherein the transmission (20) is in the form of a shiftable multi-gear transmission, and calculating the nominal torque (M_{S}) takes place when there is a torque-transmitting connection of the second drive motor (18) to the transmission (20) by virtue of the transmission ratio of the gear of the transmission (20) selected, and in a shift position in which the second drive motor (18) is decoupled from the transmission (20), by virtue of a fictional assumption of the smallest transmission ratio of the transmission (20).

8. A control unit (80) for controlling a drive train (12) in a motor vehicle (10), wherein the control unit (80) is functionally connected to two drive motors (16, 18) and a transmission (20) of the drive-train (12), and wherein the control unit is configured to carry out the method according to claim 1.

9. A drive train (12) for a motor vehicle (10), comprising:
a first drive motor (16);
a second drive motor (18);
a transmission (20) connected on its input side to the first drive motor (16) and the second drive motor (18); and
a control unit (20) configured for controlling the drive train (12), wherein the control unit is functionally connected to the first drive motor (16). to the second drive motor (18), and to the transmission (20), and wherein the control unit is configured to carry out the method according to claim 1.

10. The drive train (12) according to claim 9, wherein the first drive motor (16) is a first electric motor and the second drive motor (18) is a second electric motor (48).

11. A motor vehicle (10) having a drive train (12) comprising:
a first drive motor (16);
a second drive motor (18);
a transmission (20) connected on its input side to the first drive motor (16) and the second drive motor (18); and
a control unit (20) configured for controlling the drive train (12), wherein the control unit is functionally connected to the first drive motor (16), to the second drive motor (18), and to the transmission (20), and wherein the control unit is configured to carry out the method according to claim 1.

12. (canceled)

13. A computer-readable medium, a containing machine-readable code that, when executed by a computer, carries out the method according to claim 1.
